(19) United States
(12) Patent Application Publication
(10) Pub. No.: US 2016/0177983 A1
(43) Pub. Date: Jun. 23, 2016

(54) PACKAGING MACHINE WITH HYGIENIC PNEUMATIC CYLINDER

(71) Applicant: MULTIVAC SEPP HAGGENMÜLLER GMBH & CO. KG, Wolfertschwenden (DE)

(72) Inventor: Elmar Ehrmann, Bad Gronenbach (DE)

(21) Appl. No.: 14/962,828

(22) Filed: Dec. 8, 2015

(30) Foreign Application Priority Data
Dec. 22, 2014 (DE) 102014226830.3

(51) Int. Cl. F15B 15/28; B65B 65/00; F15B 15/14; B65B 9/10

(52) U.S. Cl. CPC F15B 15/2892; B65B 9/10; B65B 65/00; F15B 15/2807; F15B 15/14

(57) ABSTRACT

The present invention relates to a packaging machine comprising at least one work station with a lifting drive including a pneumatic cylinder. The pneumatic cylinder includes a cylinder body, a piston rod, a piston, at least one sensor, and a fastening tray for the sensor. The sensor is provided outside of the cylinder body and is adapted for detecting a position of the piston relative to the cylinder body in a contactless manner. The fastening tray is provided in an outer surface of the cylinder body and can be produced separately and installed in the cylinder body.

### CROSS-REFERENCE TO RELATED APPLICATIONS

This Application claims priority to German Patent Application Number 102014226830.3 filed Dec. 22, 2014, to Elmar Ehrmann, currently pending the entire disclosure of which is incorporated herein by reference.

### FIELD OF THE INVENTION

The present invention relates to a packaging machine.

### BACKGROUND OF THE INVENTION

DE 10 2005 038 357 A1 discloses a packaging machine with a hygienic pneumatic cylinder at a work station. The pneumatic cylinder has, in the interior of housing, sensors which are integrated therein as well as an integrated valve, so as to improve the cleaning possibilities and reduce the number of potential dirt traps, such as lines. This pneumatic cylinder is disadvantageous insofar as the sensors cannot easily be displaced. A subsequent integration of one or more sensors for end position sensing is not possible.

WO 02/068828 A1 discloses a working cylinder with adjustable sensors that are displaceably arranged in grooves on the housing. The sensors detect, in a contactless manner, specific positions of the cylinder piston in the interior of a cylinder body. The sensors are connected to a control unit integrated in the cylinder. The grooves, which are provided for the sensors, constitute a working cylinder area which is difficult to clean.

### SUMMARY OF THE INVENTION

One object of the present invention is to improve a packaging machine, such as a thermoform packaging machine, a tray sealer or a vacuum chamber machine, such that pneumatic cylinders provided at work stations can be configured to be hygienic, i.e., easy to clean, and flexible as regards the positionability of sensors.

The packaging machine according to one embodiment of the present invention comprises at least one work station with a lifting drive including a pneumatic cylinder. The pneumatic cylinder may include a cylinder body, a piston rod and a piston whose position relative to the cylinder body is detected in a contactless manner by means of at least one sensor. The sensor can be provided outside the cylinder body. The packaging machine is characterized in that a fastening tray (or fastening depression) for the sensor can be provided in an outer surface of the cylinder body. The fastening tray may be produced separately from the cylinder body and installed in the cylinder body. The fastening tray can have two longitudinal edges defining an upper plane. A circumferentially extending wall of the fastening tray may comprise four sidewalls, each enclosing an angle of less than about 87° with the upper plane. Cleaning agents or water can thus flow off easily and reliably at most installation positions of the pneumatic cylinder in the work station.

According to one embodiment, the recess has a depth of at least about 5 mm, so as to allow the sensor to be positioned as close as possible to the piston of the piston rod moving within the cylinder body for detecting the position of the piston in a contactless manner.

Two fastening trays can be provided, so as to detect or sense the position of a piston rod at its most retracted, as well as at its most extended, position.

The fastening trays can be provided on a common lateral surface of the cylinder body.

According to another embodiment, the fastening trays may be provided on two different lateral surfaces of the cylinder body, so that, in the case of pneumatic cylinders having a short cylinder body, at least two positions can be sensed.

According to one embodiment, the sensor is displaceable relative to the fastening tray in the direction of movement of the piston rod so that sensing is not limited to the end positions of the piston and the piston rod, respectively.

The sensor may be a proximity switch, and specifically a cylindrical proximity switch, which is capable of detecting the piston of the piston rod in a contactless manner. To this end, the sensor may be configured as a capacitive or an inductive proximity switch. In such proximity switches, the capacitance or the inductance of the sensor may be influenced or disturbed, when the piston is in the vicinity of the sensor. If the disturbance exceeds a predetermined threshold, this can be detected by the sensor as a sign indicating a specific position of the piston and a position signal will be transmitted.

The pneumatic cylinder can comprise a cylinder body having four lateral surfaces. The lateral surfaces may have, apart from the fastening trays, a smooth surface, so as to be easily cleanable. Smooth generally means that the surface is free from grooves, recesses or projections, for example, screw heads and the like.

The angle between a sidewall and the plane of the fastening tray may be smaller than about 75°, in one embodiment, and smaller than about 60° in another embodiment.

Other and further objects of the invention, together with the features of novelty appurtenant thereto, will appear in the course of the following description.

### DESCRIPTION OF THE SEVERAL VIEWS OF THE DRAWING

In the following, an advantageous embodiment of the present invention will be explained in more detail making reference to the drawing, in which the individual figures show:

FIG. 1 is a schematic side view of a packaging machine according to one embodiment of the present invention;

FIG. 2 is a schematic side perspective view of a pneumatic cylinder according to one embodiment of the present invention;

FIG. 3 is a schematic side perspective view of a pneumatic cylinder according to another embodiment of the present invention; and

FIG. 4 is a sectional view of the fastening tray according to one embodiment of the present invention;

Like components are provided with like reference numerals in all the figures.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

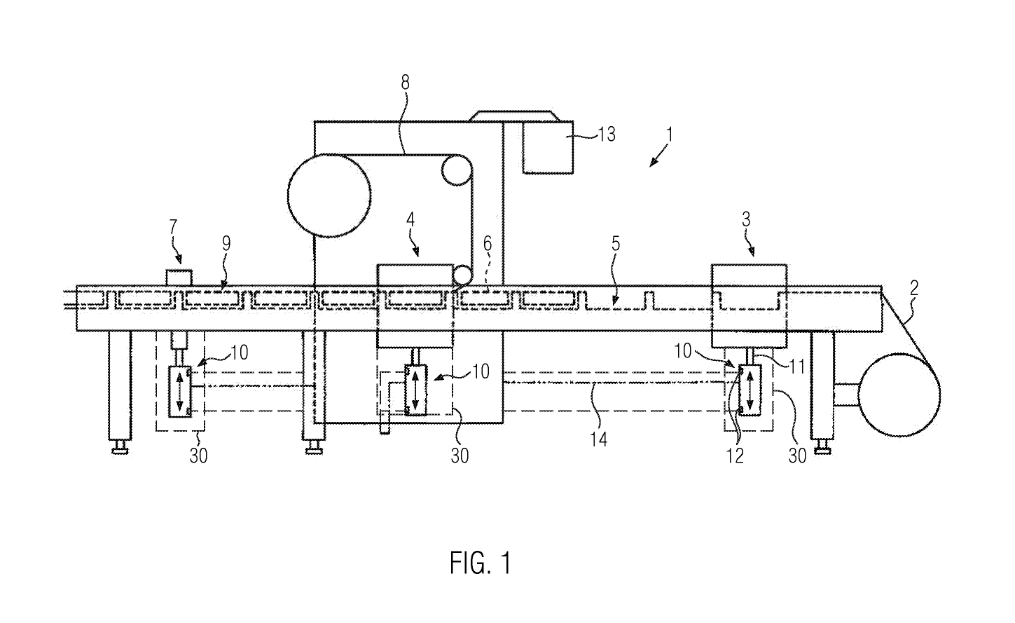

FIG. 1 shows a packaging machine 1 in the form of a thermoform packaging machine comprising a plurality of work stations, such as a forming station 3, a sealing station 4 and a cutting station 7. A film web 2 can be thermoformed in the forming station 3 thus forming a trough 5 for accommodating a product 6. In the sealing station 4, the trough 5 filled with the product 6 may have applied thereto a cover film 8 in a hermetically sealing manner. In the subsequent cutting station 7, the packages 9, which may still be attached to one another, can be cut apart and separated from one another.

The forming station 3, as well as the sealing station 4 and the cutting station 7, may comprise lifting drives 30 of different structural designs. The lifting drives may each comprise a pneumatic cylinder 10. The lifting movement need not necessarily be transmitted directly via a piston rod 11 of the pneumatic cylinder 10 to a tool unit of the work station 3, 4, 7, which is to be lifted. Depending on the respective case of use, gear mechanisms, such as a toggle lever lifting system or the like, may be provided as an intermediate unit so as to increase the lifting force, provide a guiding effect for the movement or define a plurality of application points for the lifting force on the tool unit, for example, on the forming tool lower part.

In addition, the pneumatic cylinder 10 may comprise schematically shown sensors 12 for sensing the end position of the piston rod 11 or, by means of possibly displacing the sensors 12, an arbitrary position of the piston rod 11. The sensors 12, which may be proximity switches, can be connected to a machine control unit 13. The machine control unit 13 may control via lines 14 the movement of the piston and, consequently, of the piston rod 11 by means of valves or the like that are not shown in detail.

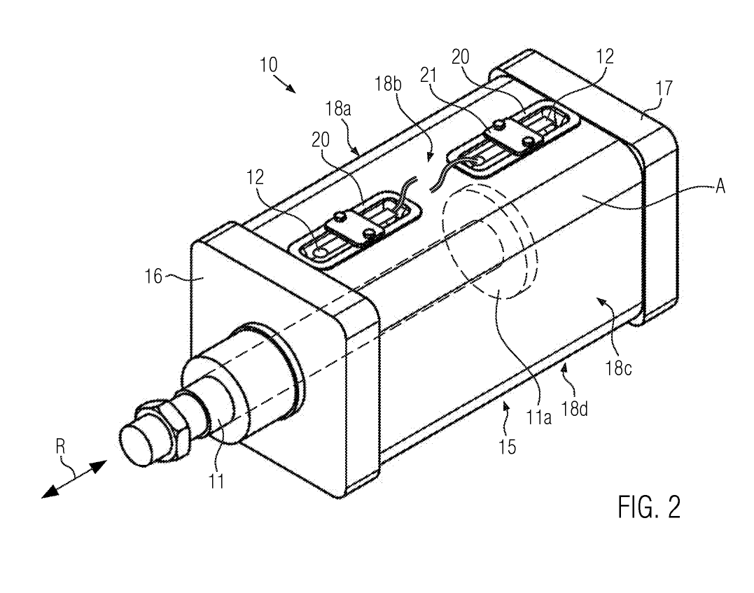

FIG. 2 illustrates a perspective view of the pneumatic cylinder 10 alone. As shown, the pneumatic cylinder 10 may comprise a piston rod 11, a piston 11a and two sensors 12 arranged on the upper outer surface A of the pneumatic cylinder 10. The piston rod 11 may be movable in a direction of movement R, as shown in FIG. 2 in the form of a double arrow. The pneumatic cylinder 10 can include a cylinder body 15, a first front closure end 16 and a second rear closure end 17. The cylinder body 15 can have four lateral surfaces 18a, b, c, d. The upwardly directed lateral surface 18b may be provided with two fastening trays 20 (or fastening depressions), and a respective sensor 12 can be fixed or clamped in position by means of a clamping bar 21 in each of these fastening trays 20. The four lateral surfaces 18a, b, c, d and, consequently, the outer surface of the cylinder body 15 can be smooth.

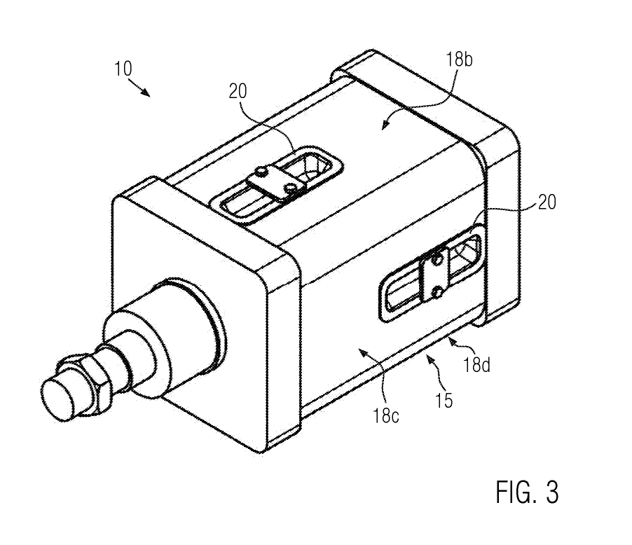

FIG. 3 depicts an alternative embodiment according to which the pneumatic cylinder 10 may comprise a respective fastening tray 20 on each of neighboring lateral surfaces 18b and 18c. This embodiment also includes a variant, which is not shown in detail and in the case of which the fastening trays 20 are provided on two opposed sides 18b, 18d, for example, on the top and bottom sides as shown in the drawing. This can be advantageous especially for cylinder bodies 15 having a small length.

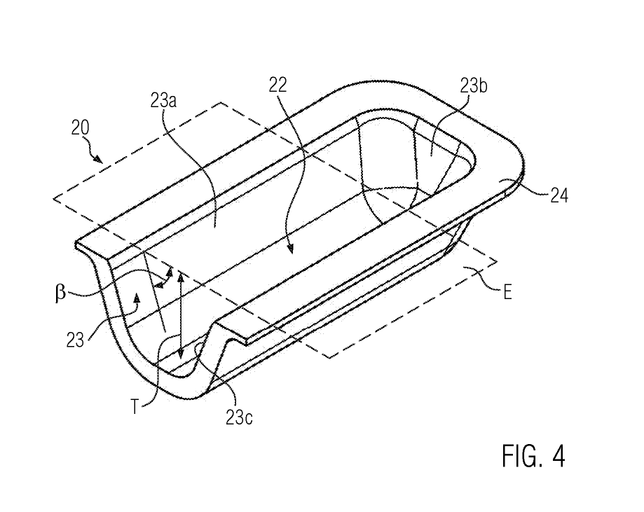

FIG. 4 shows the fastening tray 20, which may be produced separately from the cylinder body 15, in a sectional view. The fastening tray 20 may comprise a recess 22 and a circumferentially extending wall 23. The wall 23 may be divided into four sidewalls 23a, b, c, d. The left sidewall 23d, which is not visible due to the section, is arranged in opposed relationship with the right sidewall 23b. The sidewalls 23a, b, c, d may be inclined at an angle β of less than about 87°, shown here 75°, relative to a plane E defined by the circumferentially extending upper edge 24 on the upper side of the fastening tray 20. In other words, the two longitudinal edges 24 of the fastening tray 20 are located in the common plane E.

In comparison with the upper edge 24 and the plane E, respectively, the recess 22 has a depth T of, for example, about 10 mm. Water or cleaning agents which penetrate onto or into the fastening tray 20 during cleaning can automatically flow off from the fastening tray 20 downwards, without any residues remaining on the pneumatic cylinder 10. In one embodiment, the pneumatic cylinder 10 does not include a comparatively horizontal position with the fastening trays 20 facing upwards. This may be the only position of installation at which water may remain in the recess of the fastening tray 20.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A packaging machine comprising:
at least one work station with a lifting drive including a pneumatic cylinder, wherein the pneumatic cylinder comprises:
a cylinder body;
a piston rod;
a piston;
at least one sensor provided outside of the cylinder body for detecting a position of the piston relative to the cylinder body in a contactless manner; and
a fastening tray for the sensor provided in an outer surface of the cylinder body, wherein the fastening tray is produced separately and installed in the cylinder body;
wherein the fastening tray includes two longitudinal edges defining a plane, and a circumferentially extending wall having four sidewalls each enclosing an angle of less than about 87° with the plane.

2. The packaging machine according to claim 1, wherein the fastening tray has a recess defined therein having a maximum depth of at least about 5 mm with respect to the plane.

3. The packaging machine according to claim 1, wherein two fastening trays are provided.

4. The packaging machine according to claim 3, wherein the fastening trays are provided on a common lateral surface of the cylinder body.

5. The packaging machine according to claim 3, wherein the fastening trays are provided on two different lateral surfaces of the cylinder body.

6. The packaging machine according to claim 1, wherein the sensor is displaceable relative to the fastening tray in a direction of movement of the piston rod.

7. The packaging machine according to claim 1, wherein the sensor is a proximity switch.

8. The packaging machine according to claim 1, wherein the cylinder body includes four lateral surfaces each having, apart from the fastening tray, a smooth surface.

9. The packaging machine according to claim 1, wherein the angle has a maximum value of about 60°.

10. A pneumatic cylinder comprising:
a cylinder body;
a piston rod;
a piston;
at least one sensor provided outside of the cylinder body for detecting a position of the piston relative to the cylinder body in a contactless manner; and
a fastening tray for the sensor provided in an outer surface of the cylinder body, wherein the fastening tray is produced separately and installed in the cylinder body;
wherein the fastening tray includes two longitudinal edges defining a plane, and a circumferentially extending wall having four sidewalls each enclosing an angle of less than about 87° with the plane.
